(19) United States
(12) Patent Application Publication
(10) Pub. No.: US 2004/0129153 A1
(43) Pub. Date: Jul. 8, 2004

(54) Satellite printing machine for printing sheets

(76) Inventor: Ebe Hesterman, Badhoevedorp (NL)

Correspondence Address: Dreiss, Fuhlendorf, Steimle & Becker, Postfach 10 37 62, Stuttgart, D-70032, DE

(21) Appl. No.: 10/740,406

(22) Filed: Dec. 22, 2003

Related U.S. Application Data
(63) Continuation of application No. 09/890,508, filed on Aug. 21, 2001, now abandoned.
Application No. 09/890,508 is a 371 of international application No. PCT/EP00/12125, filed on Dec. 1, 2000.

(30) Foreign Application Priority Data
Dec. 3, 1999 (DE) 299 21 185.1

(51) Int. Cl. B41F 7/10; B41F 13/20

(52) U.S. Cl. 101/183; 101/479

(57) ABSTRACT

A rotary offset printing machine has a counter-pressure cylinder at which at least one printing group is disposed, as seen in the direction of rotation of the counter-pressure cylinders, between a feed system and a delivery system. The plate and/or rubber blanket cylinders of the front side printing group and/or back side printing group are constructed as cassette-shaped modular units which can be axially shifted from a use position into a servicing position to provide space for extra printing and/or imaging components.

This application is a continuation of Ser. No. 09/890,508 having a 371(c) date of Aug. 21, 2001 as the national stage of PCT/EP00/12125 PCT filed on Dec. 1, 2000 and claiming Paris Convention priority of DE 299 21 185.1 filed on Dec. 3, 1999 the entire enclosures of which are all hereby incorporated by reference.

### BACKGROUND OF THE INVENTION

This invention relates to a printing machine for printing sheets and is particularly suited for use in a satellite printing machine.

Satellite printing machines have one common central counter-pressure cylinder around which printing groups are arranged in a “satellite” configuration. The common counter-pressure cylinder is therefore the “sun” of the satellite system. It is conventionally made of thick-walled steel with a hard chromium-plated surface to prevent the ink from offsetting. Its surface is smooth and it is conventionally used only to produce counter-pressure. During printing, 4 colors can be offset or transferred onto the printing sheet, one immediately after the other, using one single gripper bite during one printing cycle. The gripper system remains closed during the printing process.

With conventional satellite printing machines (DE 43 03 796 A 1 and U.S. Pat. No. 6,438,352), the number of rubber and plate cylinder pairs surrounding the printing cylinder is limited to four for reasons of accessibility to the printing groups. With a printing device disclosed in DE 197 50 885 C1, printing groups which can be lifted and moved radially also have a highly limited available operating space. Moreover, the mobility of the entire printing group has a disadvantageous effect on its stability. U.S. Pat. No. 3,041,966 discloses printing groups which are hinged to provide access. The system is problematic in terms of design, since the supply units are also moved. All of the above mentioned machines are not equipped with imaging systems rigidly mounted at the side of the machine, away from machine generated dust and soilage.

### SUMMARY OF THE INVENTION

In view of these aspects of prior art, it is the underlying object of the present invention to propose a printing machine for printing sheets which ensures good accessibility to the printing groups and is operable with short setup and service times with or without imaging systems even for close adjacency of its printing groups for multiple, for example, five-fold front side single station, single satellite printing.

This object is achieved in accordance with the invention with the features recited in the independent claim. Further advantageous embodiments are the subject of the dependent claims.

All the plate carrying and/or rubber blanket carrying cylinders of the present invention are constructed as cassette-shaped units which can be moved axially from their operating position into a servicing position. Despite the close spacing of the printing groups, this design permits rapid and straight forward adaptation to changed printing conditions, for example, new printing plates, changed illustrations, new rubber blankets, or the like, with the good accessibility facilitating the respective work to be carried out. Adjustments or illustration processes can be performed on withdrawn cassette units in the servicing position, even while the production process is running. Furthermore, each plate cylinder of the cassette units can have a plurality, in particular five associated inking rollers which otherwise would adversely affect access to the plate cylinder and the rubber blanket cylinder. Moreover, optimum printing quality can be ensured. Above all, a satellite machine printing process with four colors and one decorative color is possible in the present invention with only one single gripper bite.

The satellite printing machine advantageously has only one single central counter-pressure cylinder, to which at least two satellite printing groups can be assigned for front side printing which are disposed, seen in the direction of rotation of the counter-pressure cylinder, between a feed cylinder and an output cylinder. Moreover, at least one additional satellite printing group can be provided for back side printing and can be disposed, as viewed, in the direction of rotation of the counter-pressure cylinder, behind the output system and in front of the feed cylinder. This type of machine configuration advantageously comprises a central rubber blanket cylinder as a counter-pressure cylinder, so that it is thereby possible to produce a multi-colored front side printing and at least one single-colored back side printing of the sheet. The material can be printed without additional transfer or turning devices during a single run and without intermediate drying.

The various cassette units can be easily connected to a control computer, so that the plate cylinder or the rubber blanket cylinder can optionally be moved from their operating position into the servicing position in which a dust-free servicing zone is preferably provided for automatic and flawless imaging processes.

The modular cassette units are advantageously usable in rotary offset printing machines in which the plate cylinder and/or the rubber blanket cylinder and/or the counter-pressure cylinder is/are moveable in the axial direction. Moveable back side printing groups can also be integrated into the system as cassette units. This overall design concept makes optimum accessibility to the drive or the operating side of the machine possible. While retaining stability, satellite printing machines can be provided with more than four front side printing groups, and additional back side printing groups without encroaching upon accessibility. Moreover, the system is sufficiently flexible that a manual or automatic plate change or an automatic imaging process can be optionally carried out.

Further details and advantageous effects of the invention can be extracted from the following description and drawings, which illustrate embodiments of the inventive satellite printing machine.

### BRIEF DESCRIPTION OF THE DRAWING

FIG. 1 shows a side view of the inventive satellite printing machine with a back side printing unit and with satellite printing groups distributed about the periphery;

FIG. 2 shows an enlarged detail of a printing group provided with a cassette unit in an operating position at the central counter-pressure cylinder;

FIG. 3 shows a plan view of a machine frame with components for the axial displacement of the cassette unit;

FIG. 4 shows a schematic representation similar to FIG. 2, with a plurality of cassette units in the operating position;

FIG. 5 shows a detail of the machine in the area of a satellite printing group with a cassette unit, which is shown in the operating position and after having been laterally displaced;

FIG. 6 shows an enlarged plan view of a satellite printing machine in the area of the central counter-pressure cylinder and its drive components;

FIG. 7 shows a schematic illustration of a satellite printing machine with cassette units in the area of the four front side printing mechanisms and with four back side printing units;

FIG. 8 shows a schematic illustration of a three-cylinder printing machine with the plate cylinder moved into the servicing position;

FIG. 9 shows a schematic illustration similar to FIG. 8 with the cassette unit, comprising the plate and rubber blanket cylinder, in the servicing position; and

FIG. 10 shows a schematic illustration of cassette units for front and back side printing in servicing positions, which are provided on both sides of the machine frame of a satellite printing machine.

### DESCRIPTION OF THE PREFERRED EMBODIMENT

FIG. 1 shows a satellite printing machine which is labeled in its entirety with 1, having a single central counter-pressure cylinder 2 to which more than four satellite printing groups S, S′ (namely five in the embodiment shown) are assigned, disposed in the direction of rotation D, between a feed cylinder 3, which forms part of a feed system, and a delivery system 4 comprising, for example, a delivery cylinder.

The satellite printing machine 1 is provided has a counter-pressure cylinder 2 which is constructed as a rubber cylinder. The counter-pressure cylinder has at least one additional associated satellite printing group W for at least single-color back side printing which is disposed, as seen in the direction of rotation D, behind the delivery system 4 and in front of the feed cylinder 3 (FIG. 1). FIG. 7 shows a plurality of satellite printing groups W for back side printing. The feed cylinder 3 and the delivery system 4 are provided with conventional gripper units or vacuum cylinders for handling the sheets being printed. Furthermore, an aligning table T is disposed upstream of the feed cylinder 3 and can be adjusted in the transverse direction, in height, and/or obliquely with respect to the direction of feed, while the printing machine is being operated.

In the present invention, the satellite printing groups S comprising a plate cylinder 5 and a rubber sheet cylinder 6 and are each structured as a cassette-held module C. After the rubber cylinder 6 is raised from the printing position (FIG. 2) at which it contacts the counter-pressure cylinder 2, the cassette units C can be moved axially into an operating and servicing position, without having to tilt or raise the cassette units C. This sliding construction increases the geometrical stability of the cassette units C, so that a low-vibration printing process is possible to eliminate distortions during printing.

The individual illustration of one of the cassette units C of FIG. 5 indicates their position in a machine frame, the cassette unit C being illustrated within the machine frame 8 in the center portion of the figure. The right side of the figure shows the cassette unit (now labeled C′) moved in the axial direction into a lateral servicing position adjacent to the machine frame 8, for example, on the operating side thereof (arrow K, FIG. 5). The entire cassette unit C′ is thereby positioned adjacent to and outside of the machine frame 8 and away from the counter-pressure cylinder 2. The cassette unit C may also be shifted towards the opposite side of the machine frame 8 in the direction of the axis of rotation A, so that the cassette unit C′ is located on the drive side (FIG. 10, left side).

With the above concept of the satellite printing machine 1, up to six indirect satellite printing groups S can be assigned to the counter-pressure cylinder 2 for front side printing, and up to six direct satellite printing groups W for indirect back side printing. In a compact construction, they may be placed directly adjacent to each other. In a preferred embodiment, the counter-pressure cylinder 2 has a circumference of 500 to 3,000 mm and the five satellite printing groups S for front side printing may be disposed in the area of the upper arc of the counter-pressure cylinder 2, so that a central angular separation P of 35° to 45° and preferably of 38° is defined between the center planes of adjacent satellite printing groups S (FIG. 1).

In the above-described configuration of the satellite printing groups S, a printing group W for back side printing is disposed in a peripheral area of the counter-pressure cylinder 2, which is opposite the printing groups S, so that the back side printing can take place in the region between the feed cylinders 3 and the satellite printing group S′, adjacent thereto in the peripheral direction D of the counter-pressure cylinder 2. It is likewise conceivable that the front side printing and the back side printing take place simultaneously in the area of this satellite printing group S′.

FIGS. 2, 3 and 5 illustrate the support of the respective cassette unit C, having the plate cylinder 5 and the rubber blanket cylinder 6 and provided for the displacement in the area of the machine frame. The cassette unit C is supported on rails 9, 10 of the respective side frame 11, 12 of the machine frame 8. The cassette unit C can be moved in a parallel fashion on these rails 9, 10 (arrow K, FIG. 5). The satellite printing groups S may also be shifted jointly together with these rails 9, 10 in guides 13,14 in the side frames 11, 12. In the embodiment shown, a linear ball bearing 15 or curved rollers 16 are provided as guides 13, 14 for the respective rails 9, 10 (FIG. 2), and the rail 10 has an underlying traverse 10′. For a positionally accurate displacement of the cylinders 5 and 6, the two rails 9 and 10 are connected by a supporting strut 19, so that the cassette units C can be shifted into the extracted position adjacent to the machine frame 8 as shown on the right-hand side of FIG. 5, and returned in the opposite direction into the use position.

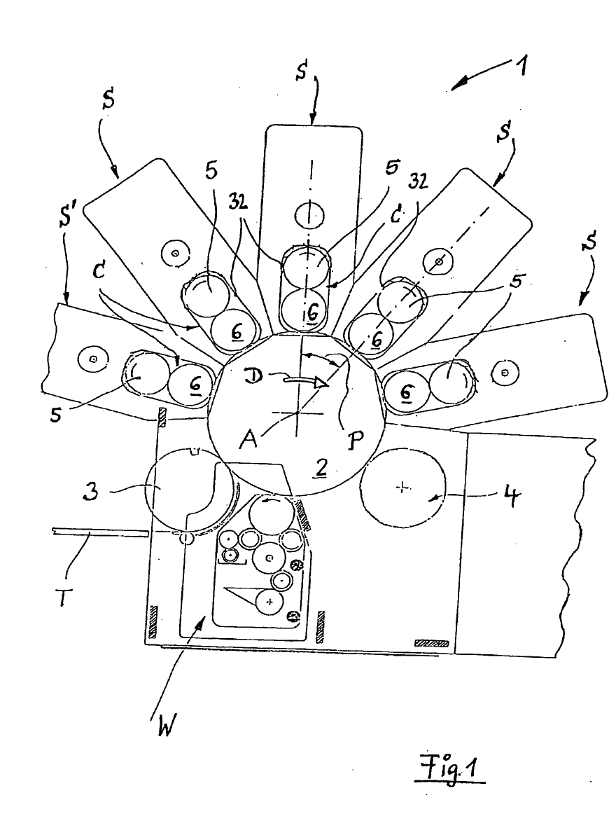

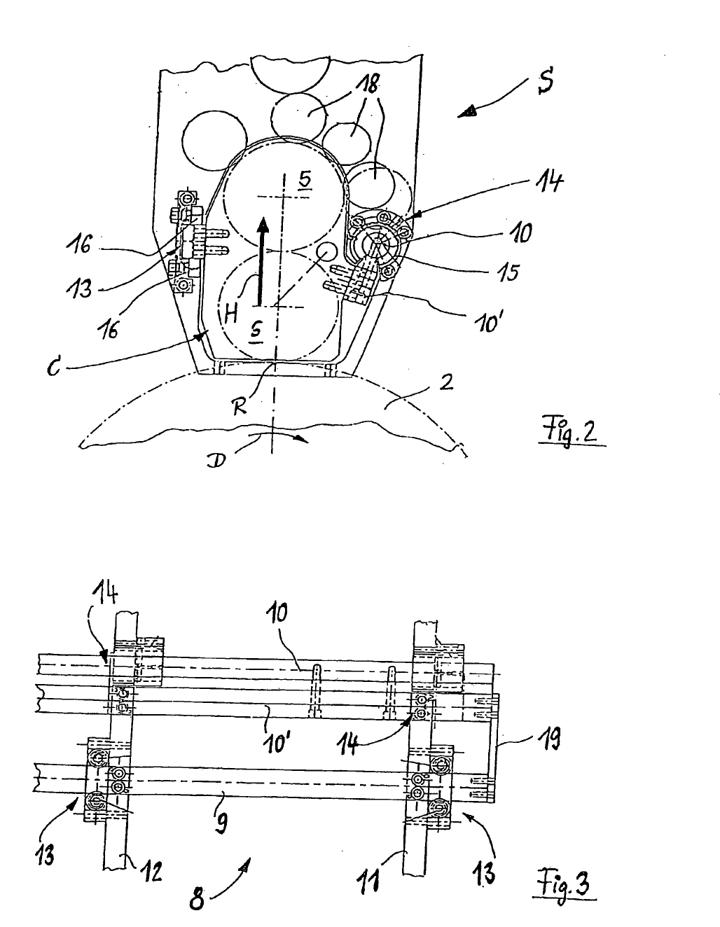

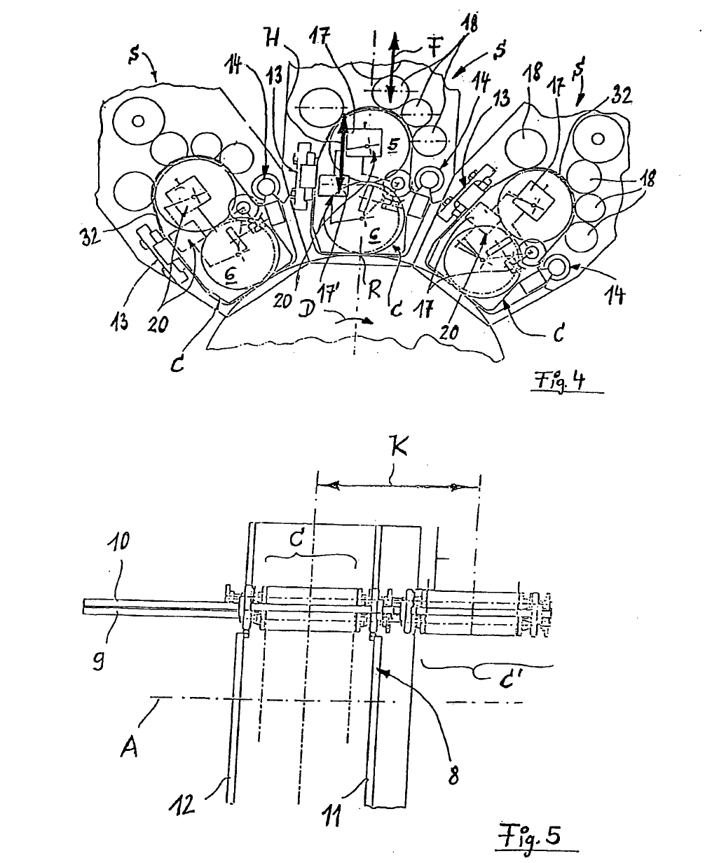

The enlarged representation of the plate and rubber blanket cylinders 5, 6 of FIG. 4 illustrate that each cylinder 5, 6 can be radially shifted within the cassette housing 32, towards and away from the counter-pressure cylinder 2 using driving means labeled in its entirety with 20, either individually and consecutively, or jointly. This radial displacement permits adjustment to the thickness of the printing stock even during operation of the machine 1 without having to move or correct the register.

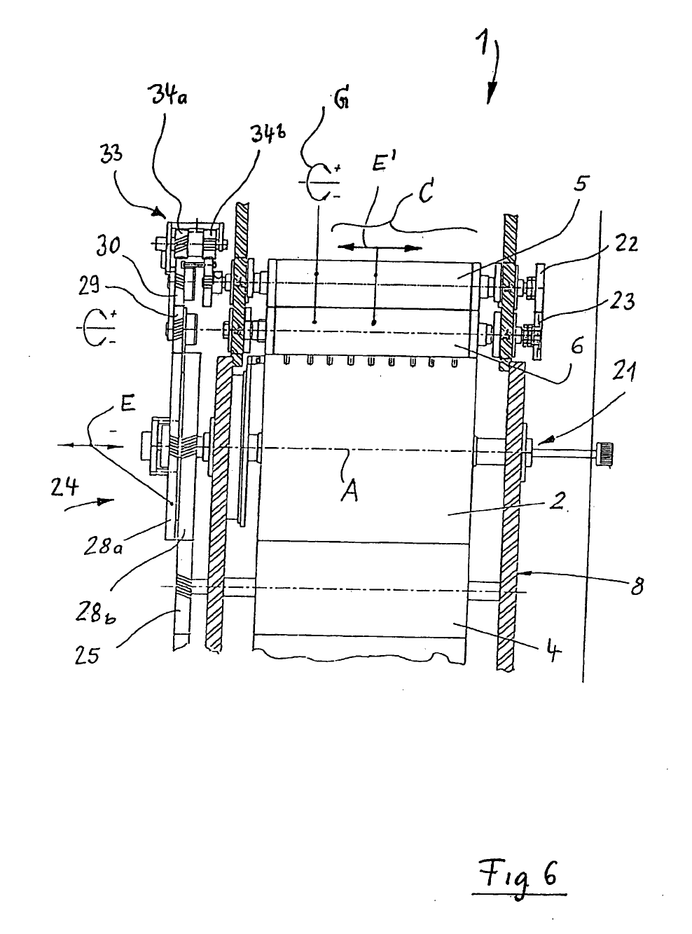

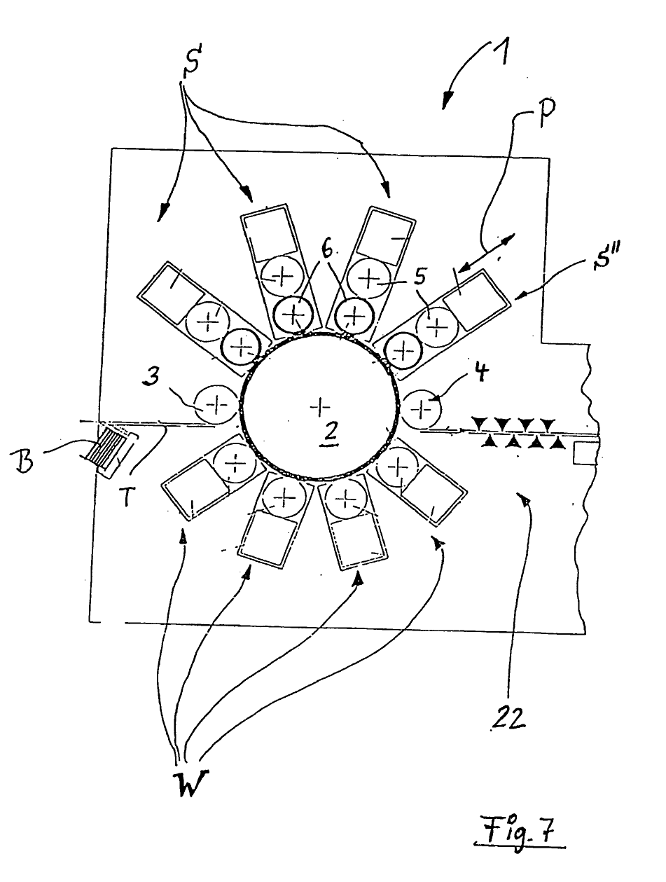

Pneumatic cylinders 17 may be used as driving means 20. In a first adjusting phase, the inking rollers 18 must be lifted in a direction of arrow F. The plate cylinder 5 and the rubber blanket cylinders 6 are then shifted with a lifting motion (arrow H) by pneumatic cylinders 17, 17′. The counter-pressure cylinder 2 is then free on its peripheral side at R and the cassette units C can be shifted. This is enabled by the drive connection for the cylinders 5, 6 designed as gear wheels 22, 23 on the side facing the direction in which the cassette unit C (FIG. 6) is shifted.

FIG. 6 shows a plan view of the counter-pressure cylinder 2 and one of its associated plate 5 and rubber blanket cylinders 6, which are each pairwise assigned to a cassette unit C. The left side of the figure shows a gear wheel connection, which extends outside the machine frame 8. The cylinders 5, 6 of the satellite printing groups S are in synchronous driving connection with the counter-pressure cylinder 2 and can be adjusted jointly in their register position relative to the counter-pressure cylinder 2. This drive concept allows for an accurate joint register adjustment of the respective cylinders of all cassette units C. An adjusting means 21 is intended for this purpose and acts on a gear wheel part 28a of a gear wheel. The associated gear wheel section 28b is stationary and interacts with a gear wheel 25 for the driving mechanism of the delivery system 4, which correspondingly remains uninfluenced by the register adjustments. This adjustment of the cylinders 5, 6 of the cassette units C can also be made while the satellite printing machine 1 is being operated.

The gear wheel connection 24 of FIG. 6 is provided with obliquely toothed gear wheel sections 28a, 28b, 29, 30 it being possible to shift the gear wheel section 28a by means of an adjusting unit 21 in the direction of the axis A (arrow E). As a result, the gear wheels 29, 30 are turned. In the embodiment shown, the gear wheel 28a acts on a double gear wheel 33, the obliquely toothed gear wheel section 34a of which is coupled to a straight geared gear wheel section 34b. The cassette unit C can be moved laterally (arrow E′) by means of said gear wheel section 34b, so that a peripheral register adjustment (arrow G) and a lateral adjustment can be made for the plate cylinder 5 and rubber blanket cylinder 6.

In one embodiment, the above-described satellite printing machine 1 is a state-of-the-art rotary offset printing machine with a plurality of automated systems, so that the imaging process for the offset plates, their semi-automated exchange, washing the rubber blankets and cooling the offset plate surface are integrated in the system. The axially displaceable cassette unit C, C′, C″, provides optimum accessibility to the area of the plate cylinder 5, the rubber blanket cylinder 6, and the counter-pressure cylinder 2 and also permits use of a large number of back side printing groups W (FIG. 7).

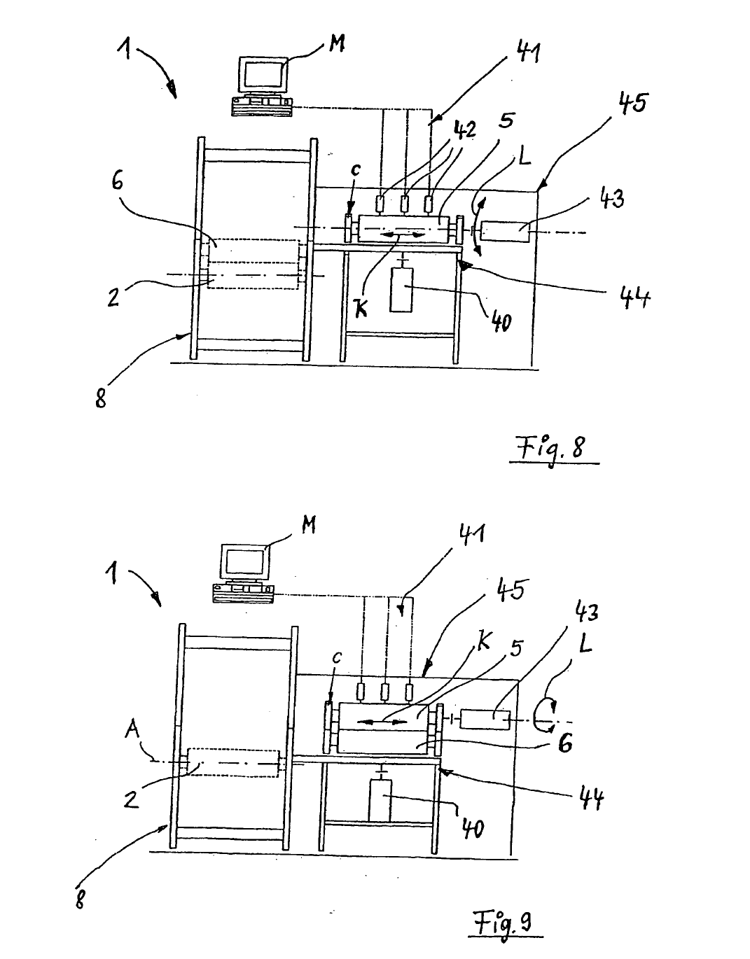

Additional embodiments of the printing machine 1 are illustrated in FIGS. 8 to 10, in which the machine is provided with a servo drive 40 for shifting the cassette units C and for carrying out additional driving functions other than the axial displacement (arrow K). In particular, additional units 41, such as imaging devices or the like, can be provided in the displacement area of the cassette units C, so that these imaging systems can be easily realized in a structurally simpler fashion. It is likewise conceivable that one of the secondary imaging systems can be used for several printing groups and, at the same time, the system can be controlled by a computer M.

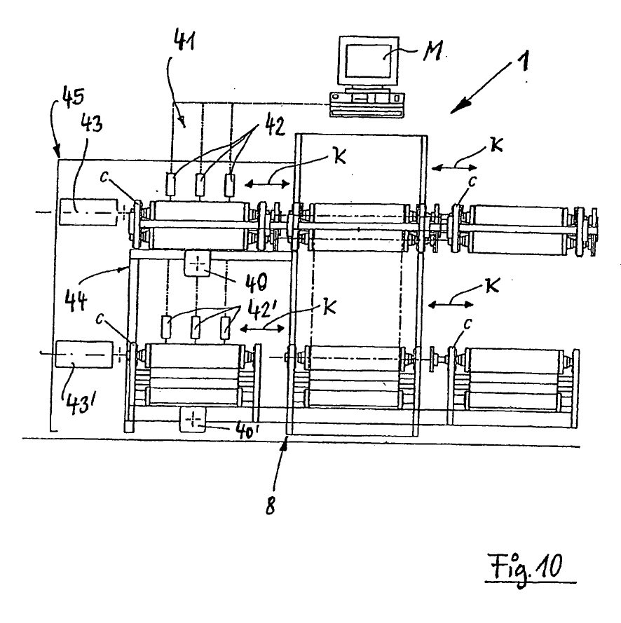

The cassette units C with servo motor drive 40 for the lateral movement, in combination with a precise linear guidance, make the imaging process possible using rigidly-mounted laser heads 42 which are optionally moved back and forth in a linear direction of motion solely by the cassette movement (arrow K) without using additional drive technology. A second servomotor 43 is provided for the rotary movement (arrow L). It is also conceivable that the imaging systems are disposed in the area of the lateral servicing position so that correspondingly displaced modular units 5 or 5 and 6 (FIG. 9) are also conveniently accessible during the continuing operation of the printing machine 1. The servo drive 40 may also function not only as the main driving mechanism, but, in addition to the imaging process, is also used for clamping the plates, fixing rubber blankets and cleaning these parts.

Additional guiding components 44 are provided for shifting particularly wide and heavy cassette units C and support the cassette units C on the respective side (FIGS. 8 and 9): drive side, right: FIG. 10: drive side, left) of the machine frame 8 so that, for example, maximum stability and an associated optimum processing precision for the imaging process are achieved.

The processing accuracy of the additional units 41, especially the laser heads 42, requires their positioning to be decoupled from the main drive and their use under dust-free conditions. Displacement accuracies on a micrometer scale are necessary during the imaging process using the servo motors 40 and 43. For this reason, a housing-shaped cover 45 is provided on the servicing side of the machine 1 and covers these components. An overpressure system or the like can ensure dust-free conditions in the region of the cover 45.

If the driving concept requires an additional driving gear wheel, provisions may be made to configure the gear wheel connection with a spring-mounted compensating gear tooth system for the gear wheels, so that the gear wheels intermesh without backlash.

Additional units may also be disposed in close proximity to the delivery system 4 of the printing machine 1 which may also have displaceable cassette units for further processing of the printing stock. Such additional systems may include a flexo system, a perforating system and/or a punching system.

The compact design of the machine concept comprising moveable cassette units C improves overall accessibility and the number of dampening and inking rollers can be increased, while maintaining the stability of the system so that the printing machine 1 is able to perform all printing tasks (for example, wet offset and dry offset processes).

In the embodiment of FIGS. 8 and 9, the printing machine is constructed as a three-cylinder machine and the plate cylinder 5 may constitute the cassette unit C and can be separately moved into the servicing position. Alternatively, the plate cylinder 5 and the rubber blanket cylinder 6 can also be shifted jointly (FIG. 9). FIG. 10 illustrates the joint shifting of the cylinders and the back side printing systems as cassette units. In this design, which can be selected by the user of the machine 1, the drive side is relocated towards the left and the operator side on the right. Automated operation is effected by the control computer M for the covered components at the left-hand side of the figure and manual operation is provided on the right-hand side of the figure.

The above-described concept of cassette units which can be shifted in the axial direction can also be extended to pairs of printing cylinders with more than three subassemblies, so that the range of applications for satellite printing groups, the accessibility to which previously was limited, is extended. Furthermore, the above-described cassette displacement can be advantageously used for pairs of printing cylinders with Y-shaped or H-shaped printing group configurations.

I claim:

1. A printing machine for rotary offset printing of a sheet, the machine comprising:
one single common counter-pressure cylinder;
a feed system structured to engage said counter-pressure cylinder to feed the sheet to said counter-pressure cylinder;
a delivery system structured to engage said counter-pressure cylinder to remove the sheet from said counter-pressure cylinder;
at least one printing group engaging said counter-pressure cylinder along a segment thereof extending from said feed system to said delivery system in a direction of rotation of said counter-pressure cylinder, each of said at least one printing group having a plate carrying cylinder and a rubber blanket carrying intermediate transfer cylinder, each plate cylinder and its associated rubber blanket cylinder of each of said at least one printing assembly being disposed in an individual or common cassette unit, shiftable sideways in a direction parallel to a rotational axial direction of the common counter-pressure cylinder, from a use position into at least one servicing position pulled completely outside of the machine and decoupled from the main drive of the machine.

2. The printing machine of claim 1, further comprising gripper means disposed on said counter-pressure cylinder for grasping the sheet.

3. The printing machine of claim 2, the machine being configured as a satellite printing machine for rotary offset printing of a sheet, wherein at least two printing groups are disposed about said counter-pressure cylinder as satellite printing groups, each printing group engaging said common counter-pressure cylinder along said segment thereof extending from said feed system to said delivery system in said direction of rotation of said common counter-pressure cylinder, each of said at least two printing groups having said plate cylinder and said rubber blanket cylinder disposed in a respective said shiftable cassette unit.

4. The printing machine of claim 2, the machine being configured as a satellite printing machine for rotary offset printing of a sheet, wherein at least five printing units are disposed about said counter-pressure cylinder as satellite printing groups, each printing group engaging said common counter-pressure cylinder along said segment thereof extending from said feed system to said delivery system in said direction of rotation of said common counter-pressure cylinder, each of said at least five printing groups having said plate cylinder and said rubber blanket cylinder disposed in a respective shiftable cassette unit.

5. The printing machine of claim 1, the machine being configured as a satellite printing machine for rotary offset printing of a sheet, wherein at least two printing units are disposed about said counter-pressure cylinder as satellite printing groups in a Y-shaped, four cylinder configuration to engage said common counter-pressure cylinder along said segment thereof extending from said feed system to said delivery system in said direction of rotation of said common counter-pressure cylinder, each of said at least two printing groups having only one plate cylinder and a common blanket, each plate cylinder of each of said at least two printing assemblies and said common blanket being disposed in a common shiftable said cassette unit, with or without said single counter-pressure cylinder.

6. The printing machine of claim 2, wherein each said cassette unit has at least two pairs of said plate and said blanket cylinder, working together in blanket to blanket configuration.

7. The printing machine of claim 1, wherein each of said cassette unit has at least one servo drive for driving at least one of said plate cylinder, said rubber blanket cylinder.

8. The printing machine of claim 7, wherein each said cassette unit has at least two pairs of said plate and said blanket cylinder, working together in blanket to blanket configuration.

9. The printing machine of claim 3, wherein each of said cassette unit has at least one servo drive for driving at least one of said plate cylinder, said rubber blanket cylinder.

10. The printing machine of claim 5, wherein each of said cassette unit has at least one servo drive for driving at least one of said plate cylinder, said rubber blanket cylinder, and said counter-pressure cylinder.

11. The printing machine of claim 1, further comprising an electronic imaging apparatus for acting on the cassette units in their servicing positions, wherein said cassette units are supported in their servicing position in a housing-shaped dust-free environment.

12. The printing machine of claim 3, further comprising an electronic imaging apparatus for acting on the cassette units in their servicing positions, wherein said cassette units are supported in their servicing position in a housing-shaped dust-free environment.

13. The printing machine of claim 1, further comprising illustrating devices and one common or a plurality of individual cleaning devices provided within a range of displacement of said cassette units.

14. The printing machine of claim 3, further comprising illustrating devices and one common or a plurality of individual cleaning devices provided within a range of displacement of said cassette units.

15. The printing machine of claim 1, further comprising means for radially lifting said rubber blanket cylinder from said counter-pressure cylinder.

16. The printing machine of claim 3, further comprising means for radially lifting said rubber blanket cylinder from said counter-pressure cylinder.

17. The printing machine of claim 3, wherein said common counter-pressure cylinder is covered by a blanket as an intermediate transfer cylinder and the satellite printing machine further comprises one or more back side printing groups engaging said common counter-pressure cylinder along a segment thereof extending, in said rotational direction of said common counter-pressure cylinder, after said delivery system and before said feed system, each of said one or more back side printing groups being disposed in its own individual cassette unit and/or having associated inking and damping groups which can all be shifted into servicing positions in a direction parallel to said rotational axial direction of said common counter-pressure cylinder.

18. The printing machine of claim 5, wherein said Y-shaped configuration satellite printing machine has one or more back side printing groups engaging said common counter-pressure cylinder covered by a blanket as an intermediate transfer cylinder along a segment extending, in said rotational direction of said common counter-pressure cylinder, after said delivery system and before said feed system, each of said one or more back side printing groups being disposed its own individual cassette unit and/or having associated inking and damping groups which can all be shifted into servicing positions in a direction parallel to said rotational axial direction of said common counter-pressure cylinder.
